(19) United States
(12) Patent Application Publication
(10) Pub. No.: US 2004/0117080 A1
(43) Pub. Date: Jun. 17, 2004

(54) Method of diagnosing a vehicle compressed-air generating system

(75) Inventors: Marco Mauro, San Remo (IT); Maria Paola Bianconi, Torino (IT); Andrea Fortunato, Orbassano (IT); Mario Gambera, Orbassano (IT)

Correspondence Address: SEED INTELLECTUAL PROPERTY LAW GROUP PLLC, 701 FIFTH AVE, SUITE 6300, SEATTLE, WA, 98104-7092, US

(73) Assignee: C.R.F. Societa Consortile per Azioni, Orbassano (IT)

(21) Appl. No.: 10/656,794

(22) Filed: Sep. 5, 2003

(30) Foreign Application Priority Data
Sep. 6, 2002 (IT) TO2002A000781

(51) Int. Cl. G06F 19/00

(52) U.S. Cl. 701/29; 340/438

(57) ABSTRACT

A method of diagnosing a vehicle compressed-air generating system, the method including the steps of: acquiring a number of operating data items associated with operation of the compressed-air generating system between turn-on of the system and subsequent turn-off of the system; processing the acquired operating data items and accumulating the data items to create at least one database; and examining the location of the data items in the database to determine malfunction and/or potential malfunction situations of the compressed-air generating system.

### BACKGROUND OF THE INVENTION

1. Field of the Invention

The present invention relates to a method of diagnosing a vehicle compressed-air generating system.

2. Description of the Related Art

Compressed-air generating systems are known in which a compressor, driven by an electric motor or combustion engine, supplies compressed air to a tank where it is stored for use by a number of on-vehicle pneumatic systems, e.g. air-powered suspensions, vehicle component pneumatic actuators, etc.

As is also known, ageing and wear of the compressor and/or members governing air flow and/or storage and/or use are responsible for a noticeable fall in the efficiency of the system.

A demand therefore exists for a method capable of fully automatically determining malfunctioning of the system, and which also provides for determining gradual deterioration of the system so as to predict pending malfunction of the system well in advance.

### BRIEF SUMMARY OF THE INVENTION

According to the present invention, there is provided a method of diagnosing a vehicle compressed-air generating system, characterized by comprising the steps of: acquiring a number of operating data items associated with operation of the compressed-air generating system between turn-on of the system and subsequent turn-off of the system; processing the acquired operating data items and accumulating the data items to create at least one database; and examining the location of the data items in said database to determine malfunction and/or potential malfunction situations of said compressed-air generating system.

### BRIEF DESCRIPTION OF THE DRAWINGS

A preferred, non-limiting embodiment of the invention will be described by way of example with reference to the accompanying drawings, in which:

FIG. 1 shows an operating flow chart of the method according to the present invention;

FIG. 2 shows a first database used in the method according to the present invention;

FIG. 3 shows a variation of the method according to the present invention;

FIG. 4 shows a second database used in the method according to the present invention.

### DETAILED DESCRIPTION OF THE INVENTION

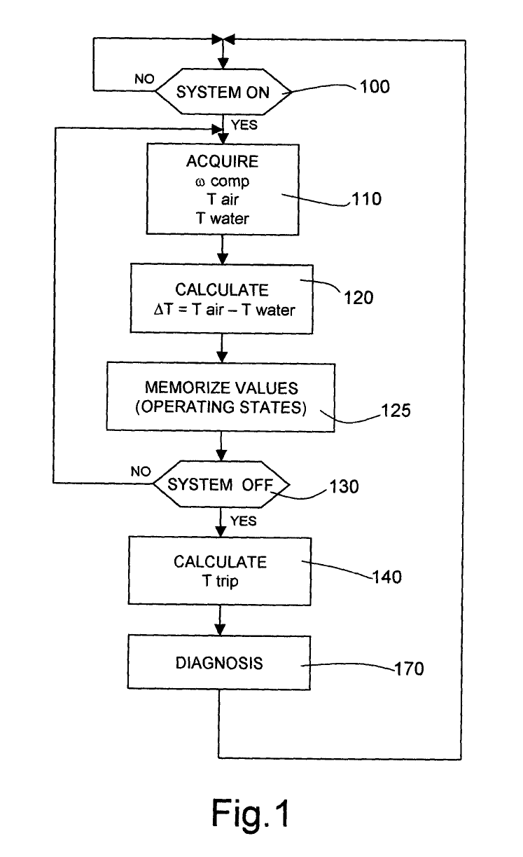

FIG. 1 shows the operations performed in accordance with a first embodiment of the method according to the present invention for diagnosing the compressed-air generating system of a vehicle, in particular an industrial vehicle (e.g. a bus).

To begin with, a block 100 determines whether the compressed-air generating system is turned on. If it is not (system off), block 100 remains on standby; conversely (system on), block 100 goes on to a block 110.

Block 110 acquires and memorizes the following quantities:

the speed ω_{comp} of the compressed-air generating system compressor;

the compressed-air temperature Tₐᵢᵣ;

a temperature associated with operation of the compressor, in particular the temperature T_{water} of the compressor cooling fluid (water) or the temperature of the compressor body.

Block 110 is followed by a block 120, which calculates the temperature difference AT between the compressed-air temperature Tₐᵢᵣ and compressor cooling fluid (water) temperature T_{water}, i.e.:

ΔT=Tₐᵢᵣ−T_{water}

Block 120 is followed by a block 125, which forms a data structure in which operating states S(ΔT, ω_{comp}) of the compressed-air generating system are determined and stored as a function of the calculated ΔT value and compressor speed ω_{comp}. They can be stored in any acceptable memory, or memorized by some other technique.

The data structure also memorizes the time lapse Ts the compressed-air generating system remains in each operating state S(ΔT, ω_{comp}).

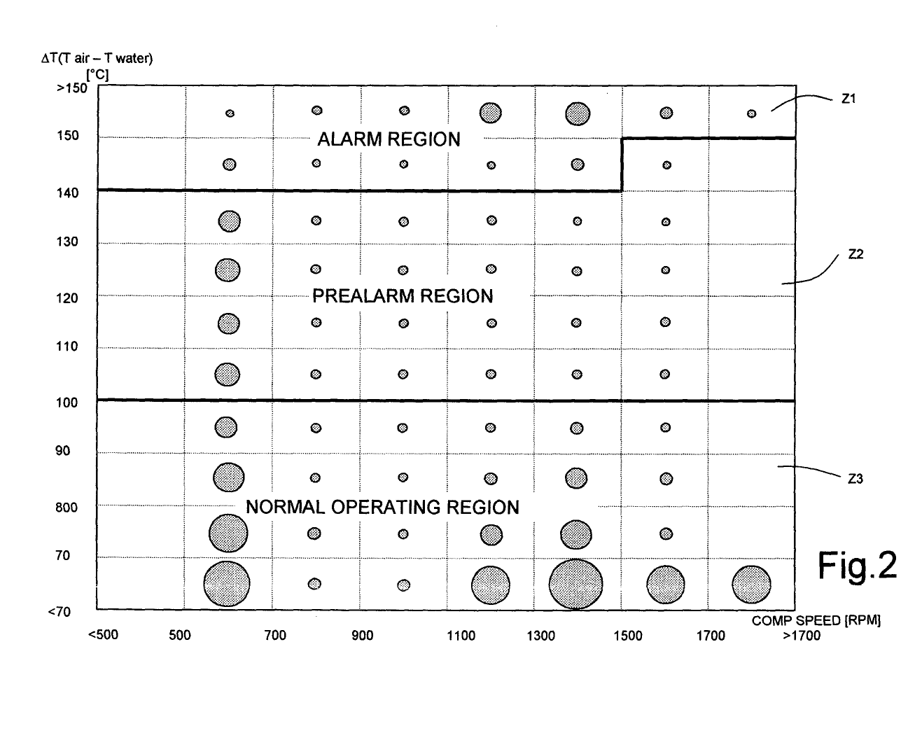

For example, the database can be represented in the form of a Cartesian X-Y spot diagram—FIG. 2—in which each spot corresponds to an operating state; and the diameter of the spot shows how long the operating state is recorded, i.e. how long the compressed-air generating system remains in that particular operating state.

Block 125 is followed by a block 130, which determines whether the compressed-air generating system has been turned off. If it has not (system on and running), block 130 goes back to block 110; conversely (system off and blocked), block 130 goes on to a diagnosis block 170.

On exiting block 130, the total trip time Ttrip (measured in seconds, minutes or hours) between turn-on and turn-off of the compressed-air generating system is also calculated (block 140 between blocks 130 and 170), and equals the sum of the time lapses in the various recorded operating states.

The operating states are thus memorized and accumulated in different operating condition bands (shown by a grid in FIG. 2).

Alternatively or in addition, as opposed to the time lapse in each operating state, the percentage of total trip time Ttrip spent in that particular operating state may be memorized.

When the compressed-air generating system is turned off, the three-dimensional data structure thus contains the time lapses in the various recorded operating states.

Repeated system trips generate a database containing all the states in which the system has operated.

According to the present invention, block 170 periodically checks the database containing all the accumulated data structures to determine any malfunction situations.

For which purpose, the X-Y diagram map (FIG. 2) shows various calibratable regions, including:

an alarm region Z1;

a prealarm region Z2; and

a normal or safe operating region Z3.

Regions Z1, Z2 and Z3 in the X-Y diagram can be calibrated as a function of the characteristics of the compressed-air generating system.

The check by block 170 may be performed in three ways:

by checking the data structure at the end of each operating cycle of the compressed-air generating system to determine instantaneous malfunctions (e.g. location of at least one operating state in alarm region Z1);

by checking the data structures of a number of operating cycles of the same system to determine gradual deterioration (e.g. migration of accumulated operating states from normal operating region Z3 to regions Z1 and Z2;

by comparing the data structures of different compressed-air generating systems to determine anomalies in one system with respect to others acting as a reference.

Defective operation of the system can be established on the basis of various criteria, including:

an operating state time lapse in alarm region Z1 over and above a given maximum value;

migration of operating state time lapses towards alarm region Z1;

the operating state pattern of one system differs from that of a number of other systems.

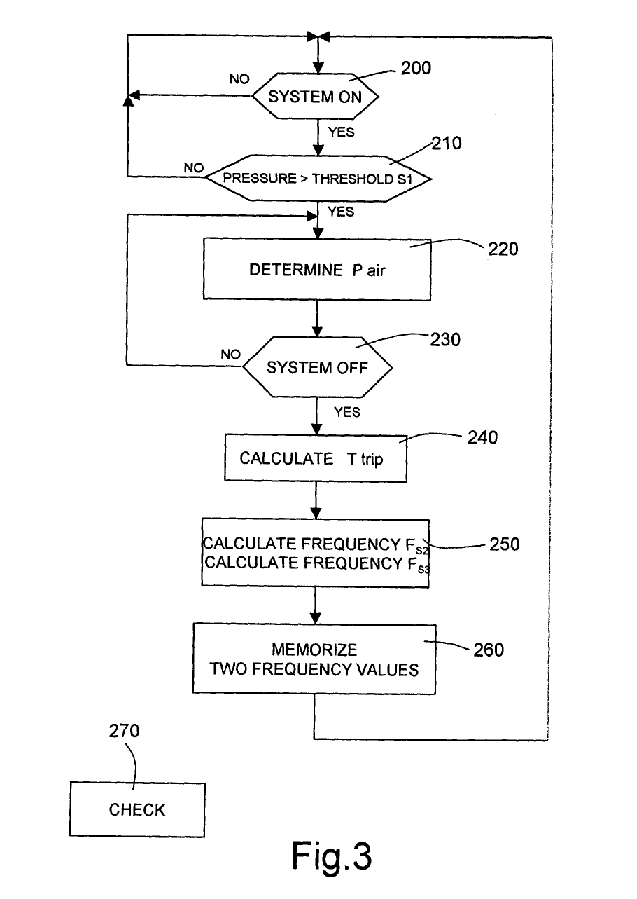

In the alternative method shown in FIG. 3, a block 200 determines whether the compressed-air generating system is turned on. If it is not (system off), block 200 remains on standby; conversely (system on), block 200 goes on to a block 210.

Block 210 determines whether the pressure Pₐᵢᵣ of the compressed air generated by the system is above a threshold pressure value S1, i.e.:

Pₐᵢᵣ>S1

If it is not (Pₐᵢᵣ<S1), block 210 goes back to block 200; conversely (Pₐᵢᵣ>S1), block 210 goes on to a block 220.

In other words, the system remains in the block 200-210 loop until the pressure of the compressed air generated by the system increases sufficiently to reach threshold value S1.

Block 220 determines the time pattern of pressure Pₐᵢᵣ, which, as is known, has a substantially alternating sinusoidal time pattern in which pressure peaks alternate with lower-pressure regions (dips).

More specifically, block 220 determines when the recorded pressure Pₐᵢᵣ exceeds a second threshold value S2 and falls below a third threshold value S3 preferably lower than second threshold value S2.

Block 220 is followed by a block 230, which determines whether the compressed-air generating system has been turned off. If it has not (system on), block 230 goes back to block 220; conversely (system off), block 230 is followed by a block 240, which determines the time Ttrip between turn-on (block 200) and turn-off (block 230) of the system, i.e. the time Ttrip the compressed-air generating system has been on continuously, thus performing a complete operating cycle.

Block 240 is followed by a block 250, which calculates the frequency F_{S2} of pressure values above threshold S2, i.e. determines the relationship between the number of occurrences in which pressure Pₐᵢᵣ exceeds threshold S2, and the time Ttrip the compressed-air generating system has been on continuously.

Block 250 also calculates the frequency F_{S3} of pressure values below threshold S3, i.e. determines the relationship between the number of occurrences in which pressure Pₐᵢᵣ is below threshold S3, and the time Ttrip the compressed-air generating system has been on continuously.

Block 250 is followed by a block 260, which, for each operating cycle examined, stores in the respective frequency F_{S2} value of the pressure values above threshold S2.

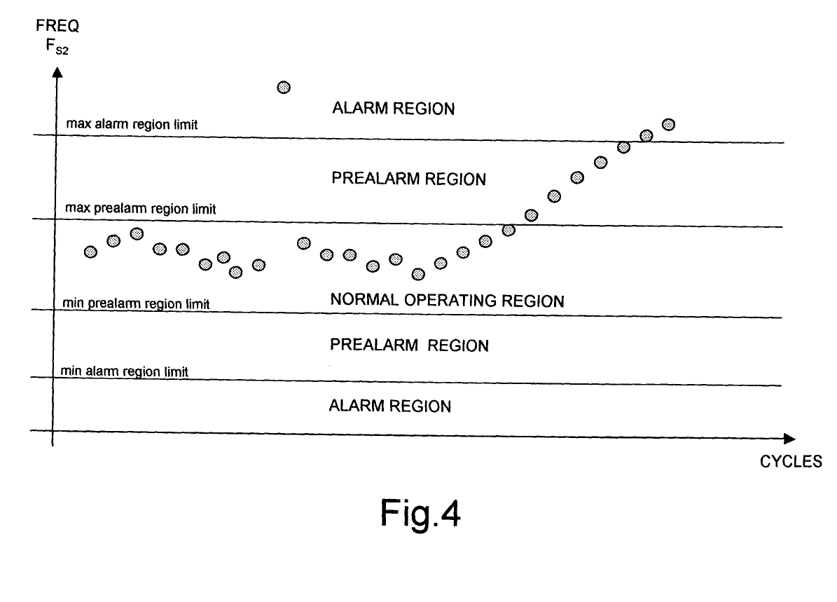

A first two-dimensional database is thus formed (FIG. 4), which can be represented in the form of a Cartesian diagram, the X axis of which shows successive operating cycles, and the Y axis the F_{S2} frequency values associated with each cycle.

Block 260 also stores, for each operating cycle examined, the respective frequency F_{S3} value of the pressure values below threshold S3.

A second two-dimensional database is thus formed, which can be represented in the form of a Cartesian diagram, the X axis of which shows successive operating cycles, and the Y axis the F_{S3} frequency values associated with each cycle.

According to the present invention, a process independent of the operations performed in blocks 200-260, and indicated by a block 270 in FIG. 3, periodically checks one or both databases to determine any malfunction situations.

Defective operation of the compressed-air generating system can be established on the basis of various criteria, including:

F_{S2} and F_{S3} frequency values above upper prealarm and alarm values;

F_{S2} and F_{S3} frequency values below lower prealarm and alarm values;

migration of F_{S2} and F_{S3} frequency values towards prealarm and alarm values.

The prealarm and alarm values are calibratable.

The method according to the present invention therefore provides for fully automatically determining a malfunction situation of the compressed-air generating system.

1. A method of diagnosing a vehicle compressed-air generating system, characterized by comprising the steps of:
acquiring a number of operating data items associated with operation of the compressed-air generating system between turn-on of the system and subsequent turn-off of the system;
processing the acquired operating data items and storing the data items to create at least one database; and
examining the data items in said database to determine malfunction and/or potential malfunction situations of said compressed-air generating system.

2. A method as claimed in claim 1 wherein said step of acquiring operating data items associated with operation of the compressed-air generating system comprises the step of acquiring:
the speed ω_{comp} of the compressed-air generating system compressor;
the compressed-air temperature Tₐᵢᵣ; and
a temperature associated with operation of the compressor, in particular the temperature T_{water} of the compressor cooling fluid or the temperature of the compressor body.

3. A method as claimed in claim 2 wherein said step of acquiring operating data items comprises the step of calculating the temperature difference ΔT between said compressed-air temperature Tₐᵢᵣ and said temperature (T_{water}) associated with operation of the compressor: ΔT=Tₐᵢᵣ−T_{water}.

4. A method as claimed in claim 3 wherein said accumulating step comprises the step of forming a data structure in which are memorized a number of operating states, each defined as a function of the value of the calculated temperature difference (ΔT) and as a function of the acquired speed ω_{comp}.

5. A method as claimed in claim 1 wherein said step of acquiring operating data items comprises the steps of:
acquiring the time pattern of the pressure (Pₐᵢᵣ) of the compressed air generated by said system; said pressure (Pₐᵢᵣ) having an alternating time pattern, in which pressure peaks alternate with low-pressure regions;
determining the relationship between said pressure and at least one pressure threshold value;
repeating said step of acquiring the time pattern of the pressure for a work cycle of said system ranging between turn-on and turn-off of the system;
calculating the ratio between the number of occurrences in which, within a cycle, the acquired pressure Pₐᵢᵣ assumes a predetermined relationship with respect to said threshold value, and the time Ttrip the compressed-air generating system has been on;
storing, for each operating cycle, the respective calculated ratio value to create said database.

6. A method as claimed in claim 5 wherein said step of acquiring the time pattern of the pressure is preceded by an initializing step until the pressure generated by the system reaches a minimum threshold value.

7. A method as claimed in claim 1 wherein said step of examining the location of the data items accumulated in said database comprises the steps of:
defining, within said database, different regions corresponding to different operating states of said compressed-air generating system; and
determining the location of said data items within said regions.

8. A method as claimed in claim 7 wherein said step of examining the location of the data items in said database comprises the step of determining when a maximum time value associated with an acquired operating state located in an alarm region is exceeded.

9. A method as claimed in claim 8, wherein said step of examining the location of the data items in said database comprises the step of determining migration of said operating states towards an alarm region.
